(19) United States
(12) Patent Application Publication
(10) Pub. No.: US 2026/0171571 A1
(43) Pub. Date: Jun. 18, 2026

(54) CARRIER FRAMEWORK, BATTERY PACK INCLUDING THE CARRIER FRAMEWORK, AND ELECTRIC VEHICLE INCLUDING THE BATTERY PACK

(71) Applicant: SAMSUNG SDI CO., LTD., Yongin-si (KR)

(72) Inventor: Guenter FLOH, Graz (AT)

(21) Appl. No.: 19/333,226

(22) Filed: Sep. 18, 2025

(30) Foreign Application Priority Data
Dec. 18, 2024 (EP) 24221233.0

(51) Int. Cl. H01M 50/242; B60R 19/56; H01M 50/224; H01M 50/249; H01M 50/262

(52) U.S. Cl. CPC H01M 50/242; H01M 50/224; H01M 50/249; H01M 50/262; B60R 19/565; H01M 2220/20

(57) ABSTRACT

A carrier framework for a battery pack includes: a frame including two pairs of opposing side beams; a cross beam connecting a first pair of the opposing side beams of the frame; and a stiffening beam fixed to a second pair of the opposing side beams of the frame and to the cross beam.

### CROSS-REFERENCE TO RELATED APPLICATION

The present application claims priority to and the benefit of European Patent Application No. 24221233.0, filed on Dec. 18, 2024, in the European Patent Office, the entire disclosure of which is incorporated herein by reference.

### BACKGROUND

### 1. Field

Aspects of embodiments of the present disclosure relate to a carrier framework, a battery pack including the carrier framework, and an electric vehicle including the battery pack.

### 2. Description of the Related Art

A battery module is formed of a plurality of battery cells connected together in series and/or in parallel. The battery module is formed by interconnecting electrode terminals of the plurality of battery cells, with the number and connection configuration of the battery cells depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules or respectively, the battery cells, may be connected in a series, parallel, or series/parallel configuration to deliver the desired voltage, capacity, and/or power density. Components of a battery pack include the individual battery modules and interconnects, which provide electrical conductivity between the battery modules.

A battery pack requires suitable mechanical connections between the individual components, for example, of the battery modules, and between the battery modules and a supporting structure of the vehicle. These connections should remain functional and safe throughout the average service life of the battery system. Further, installation space and interchangeability design criteria should be met, especially in mobile applications.

Mechanical integration of battery modules may be achieved by providing a carrier framework and by positioning the battery modules thereon. Fixing the battery cells or battery modules to the carrier framework may be achieved by fitted depressions in the framework or by mechanical interconnectors, such as bolts or screws. Alternatively, the battery modules may be confined by fastening side plates to lateral sides of the carrier framework. In some cases, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is usually made of aluminum or an aluminum alloy to reduce the total weight of the construction.

Conventional battery systems, despite any modular structure, usually include a battery housing that acts as enclosure to seal the battery system against the environment and provides structural protection for the battery system's components. Housed battery systems are usually mounted as a whole into their application environment, such as an electric vehicle. Thus, the replacement of defective or damaged system parts, for example, a defect battery submodule, requires dismounting the entire battery system and removal of its housing. Even defects in small and/or cheap system parts may lead to dismounting and replacement of the entire battery system and its separate repair. Because high-capacity battery systems are expensive, large, and heavy, this procedure is burdensome and the storage, for example, in the mechanic's workshop, of the bulky battery systems is difficult.

### SUMMARY

In automotive applications, stiffness and frequency reduction of battery system components are important topics and relevant design considerations. However, in extra-large battery-packs, these issues are even more prominent. Extra-large batteries should avoid structural problems faced due to their length and width. A particular problem in the development of EV batteries is the achievement of sufficient stiffness in the pack as well as the suppression of certain frequencies that could be problematic over long-term usage.

Accordingly, according to embodiments of the present disclosure, a stiffened carrier framework for a battery pack of an electric vehicle is provide.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a carrier framework for a battery pack of an electric vehicle includes a frame including two pairs of opposing side beams; a cross beam connecting a first pair of the opposing side beams; and a stiffening beam fixed to a second pair of the opposing side beams and to the cross beam.

According to another embodiment of the present disclosure, a battery pack includes the carrier framework as described above.

Another embodiment of the present disclosure provides an electric vehicle including the battery pack as described above.

Further aspects and features of the present disclosure can be learned from the following description and the appended claims.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic bottom perspective view of a carrier framework according to an embodiment.

FIG. 2 is a schematic perspective view of a stiffening beam according to an embodiment.

FIG. 3 is a schematic perspective view of a stiffening beam according to the same embodiment from another perspective.

FIG. 4 is a schematic cross-sectional view of the stiffening beam taken along the line A-A′ in FIG. 3.

FIG. 5 is a schematic cross-sectional view of the stiffening beam taken along the line B-B′ in FIG. 3 according to another embodiment.

FIG. 6 is a schematic view of an electric vehicle according to an embodiment.

### DETAILED DESCRIPTION

Reference will now be made, in detail, to embodiments, examples of which are illustrated in the accompanying drawings. Aspects and features of embodiments will be described below with reference to the accompanying drawings.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly. Herein, the terms “upper” and “lower” are defined according to the z-axis. For example, the upper cover is positioned at the upper part of the z-axis, and the lower cover is positioned at the lower part thereof.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification and should not be interpreted in an idealized or overly formal sense unless expressly so defined herein.

According to an embodiment of the present disclosure, a carrier framework for a battery pack of an electric vehicle includes a frame including two pairs of opposing side beams, at least one cross beam connecting two opposing side beams, and a stiffening beam fixed to the two other opposing side beams and to the at least one cross beam.

The stiffening beam provides additional strength for the carrier framework. For example, the arrangement of the stiffening beam increases the overall stiffness without reducing the volumetric energy density of the battery pack. Thereby, the resonance frequency of the carrier framework may also be adjusted to avoid vibrating at frequencies which may damage a battery pack to which the carrier framework is installed. In other words, the design of the carrier framework may avoid damaging resonance frequencies by shifting them to other frequencies, thereby prolonging the life cycle of the carrier framework. In addition, the stiffening beam dampens the oscillating behavior of the battery pack and reduces inherent frequencies.

According to another embodiment, the stiffening beam has first through holes through which the stiffening beam is fixed to the at least one cross beam. The stiffening beam and the cross beam may be connected by fixing elements (e.g., screws or bolts) through the first through hole, thereby providing a firm connection between both members. Further, resonance frequencies may be transferred efficiently, thereby adjusting the resonance frequency of the entire carrier framework.

According to another embodiment, the carrier framework further includes bottom plates extending between the at least one cross beam and the side beams, with the bottom plates being fixed to the stiffening beam. The bottom plates may carry the batteries or, respectively, battery modules. The bottom plates may cover the entire area between the two pairs of opposing side beams. A bottom plate may be fixed to a cross beam. The bottom plates may have a different length. In some embodiments, the bottom plates may be connected to each other in a form-fitting manner and/or a force-fitting manner.

According to another embodiment, the bottom plates have structural elements on a side facing the stiffening beam, which protrude from the plane of the bottom plates and rest against the stiffening beam. The structural element may provide stiffness to the bottom plate. Stiffness may relate to bending stiffness and/or torsional stiffness. By resting against the stiffening beam, the overall stiffness of the carrier framework is further increased, thereby further altering the resonance frequency.

According to another embodiment, the stiffening beam has second through holes in an area not facing the structural elements of the bottom plates and includes bushings that attach to the second through holes and extend to the bottom plate. The stiffing beam may be fixed to the bottom plate via the bushing. Fixing the bottom plate to the stiffening beam further strengthens the carrier framework. The bushings may be fixed to the stiffing beam in a form-fitting manner, a force-fitting manner, and/or a materially bonded manner.

According to another embodiment, the structural elements have a U-shaped contour on the side facing the stiffening beam, with the U-shaped contour running transversely to the stiffening beam. A U-shaped contour is another option for stiffening the bottom plate. A U-shape has the advantage of being easily manufacturable by bending the edges of a sheet metal and arranging them next to each other, thereby yielding a flat surface on one side and several U-shapes arranged next to each other on the other side.

According to another embodiment, the stiffening beam has a hollow profile. The hollow profile provides high stiffness while maintaining low weight compared to a solid beam, which may have similar rigidity but is much heavier. Low weight is a big advantage for electric vehicles.

According to another embodiment, the hollow profile includes at least two hollow chambers. When openings are present in one hollow chamber, this location may be weakened. However, the second hollow chamber, without the openings, may provide rigid support in this weakened area to compensate.

According to another embodiment, the stiffening beam further includes a wall between adjacent ones of the at least two hollow chambers. Due to the wall, even if one hollow chamber has a hole, the other chamber maintains a square, unobstructed profile, thereby maintaining rigidity of the stiffening beam.

According to another embodiment, the stiffening beam is made of aluminum. Aluminum is light weight and suitable for electric vehicle applications.

According to another embodiment, a battery pack of an electric vehicle includes the carrier framework as described above.

An electric vehicle may include the battery pack. The electric vehicle may further include an underrun protection cover, and the stiffening beam may be arranged between the underrun protection cover and the bottom plates. When an underrun protection cover is present, a space (or gap) may be formed between the carrier framework and the underrun protection cover. The stiffening beam may fill a gap corresponding to the space and stiffen the carrier framework without requiring an increase of the gap. That is, additional space may not be required for installation of the stiffening beam.

According to another embodiment, a resonance frequency of the battery pack is in a range between about 45 and about 49 Hz. In some embodiments, the resonance frequency is in a range between about 45 and about 48 Hz. In some embodiments, the resonance frequency is in a range between about 45.5 and about 47 Hz. These frequency ranges are uncommon to be achieved in electric vehicles, thereby avoiding amplified vibrations, and reducing the burden on the battery pack and, thereby, on the electric vehicle over its life cycle, thereby prolonging its life cycle.

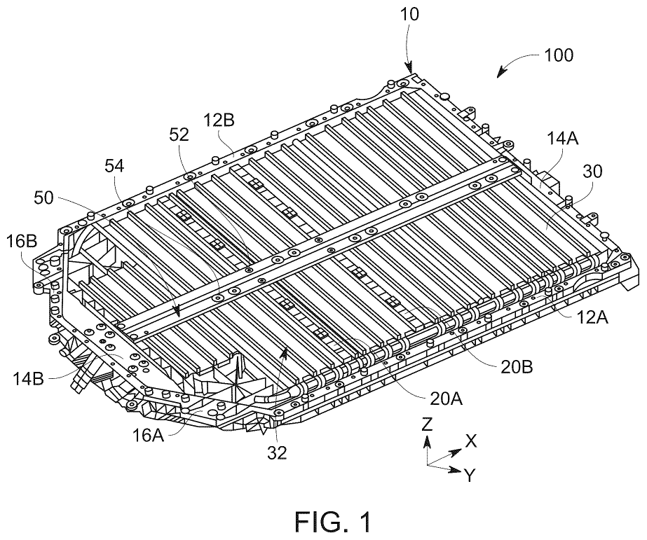

FIG. 1 is a schematic perspective view of a bottom of a carrier framework 100 according to an embodiment. The carrier framework 100 may be part of a battery pack and may accommodate battery cells.

The carrier framework 100 includes a frame 10 including two pairs of opposing side beams 12A, 12B, 14A, 14B. A first pair of side beams includes a first side beam 12A extending along a longitudinal direction of the carrier framework 100. The longitudinal direction of the carrier framework 100 is the direction in which the carrier framework 100 has its largest extension (or largest dimension). In FIG. 1, this direction is indicated by the X-axis. The first pair of side beams further includes a second side beam 12B extending parallel to the first side beam 12A. A second pair of side beams includes another first side beam 14A extending perpendicular to the longitudinal direction, which may be referred to as a width direction of the carrier framework 100. In FIG. 1, this direction is indicated by the Y-axis. Another second side beam 14B of the second pair of side beams extends parallel to the other first side beam 14A. According to the illustrated embodiment, the carrier framework 100 further includes a first angled beam 16A and a second angled beam 16B connecting the first side beam 12A and the second side beam 12B, respectively, to the second side beam 14B.

The carrier framework 100 further includes at least one cross beam 20A, 20B connecting two opposing side beams 12A, 12B of the carrier framework 100. In the illustrated embodiment, a first cross beam 20A and a second cross beam 20B are shown extending between the first side beam 12A and the second side beam 12B. The cross beams 20A, 20B are fixed to the two opposing side beams 12A, 12B.

The carrier framework 100 further includes a stiffening beam 50 fixed to the two other opposing side beams 14A, 14B of the frame 10 and to the cross beams 20A, 20B. The stiffening beam 50 has first through holes (e.g., first openings) 52 through which the stiffening beam 50 is fixed to the cross beams 20A, 20B. In the illustrated embodiment, the stiffening beam 50 is illustrated as having two first through holes 52 corresponding to each cross beam 20A, 20B, but the present disclosure is not limited thereto. For example, the stiffening beam 50 may have one, three, four, or more first through holes in other embodiments.

In the illustrated embodiment, the carrier framework 100 includes bottom plates 30 extending between the at least one cross beam 20A, 20B and the side beams 12A, 12B, 14A, 14B. The bottom plates 30 are fixed to the stiffening beam 50. Further, the bottom plates 30 include structural elements 32 on a side facing the stiffening beam 50, which protrude from a plane of the bottom plates 30 and rest against (e.g., contact) the stiffening beam 50. In the illustrated embodiment, the structural element 32 is implemented as a U-shaped contour on the side of the bottom plate 30 facing the stiffening beam 50, with the U-shaped contour running transversely to the stiffening beam 50.

In the illustrated embodiment, the stiffening beam 50 further includes second through holes (e.g., second openings) 54 in an area not facing the structural elements 32 of the bottom plates 30 and bushings 56 (see, e.g., FIGS. 3 to 5) that attach to the second through holes 54 and extend to the bottom plate 30. For example, the bushings 56 fill the distance (or the gap) between the stiffening beam 50 and the bottom plate 30, thereby providing a firm connection. That is, the stiffing beam 50 may be fixed to the bottom plate 30 via the bushing 56.

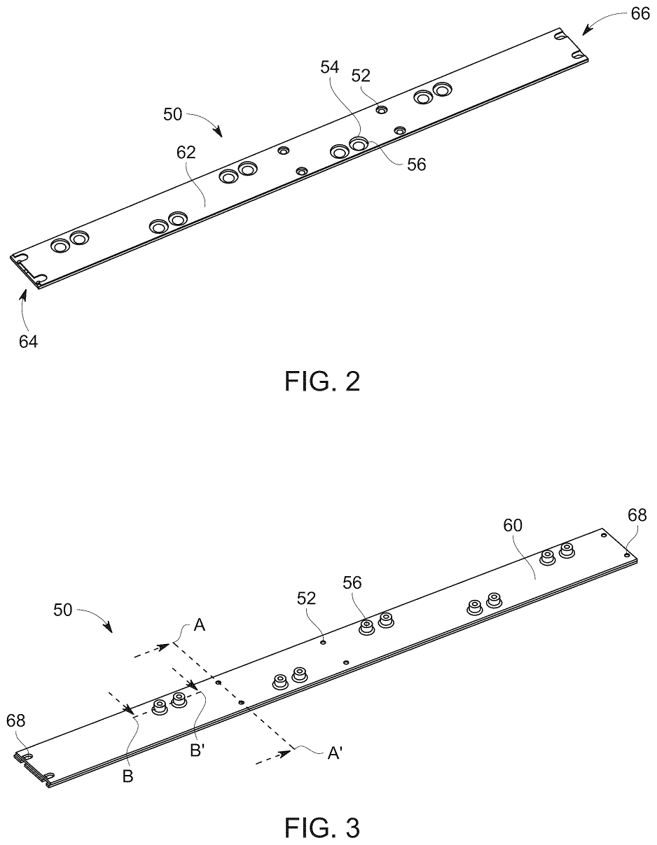

FIG. 2 is a schematic perspective view of the stiffening beam 50 according to the embodiment shown in FIG. 1. The explanations provided above with reference to FIG. 1 apply accordingly. The stiffening beam 50 has two distal ends, that is, a first end 64 and a second end 66. FIG. 2 shows a lower surface 62 of the stiffening beam 50, which would face away from the carrier framework 100 when the stiffening beam 50 is installed on the carrier framework 100. The lower surface 62 of the stiffening beam 50 may be flat, that is, without protrusions extending beyond its surface.

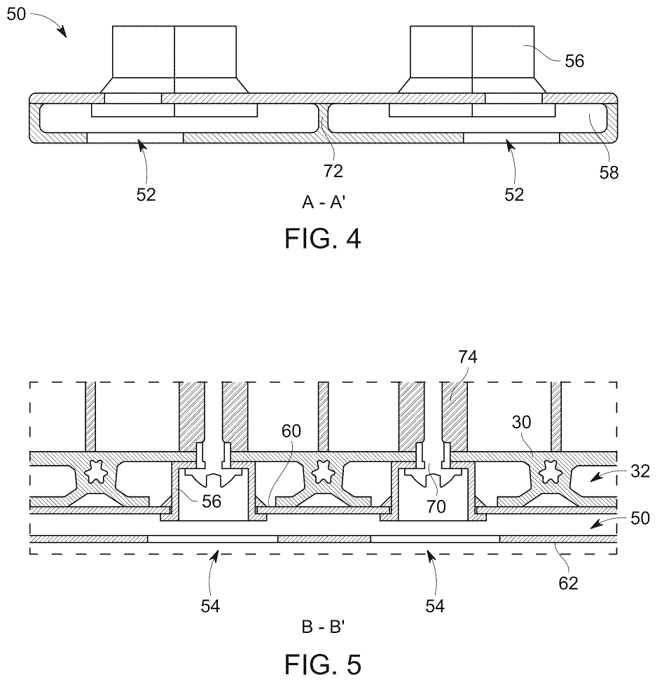

As will be explained in more detail with reference to FIG. 4, the stiffening beam 50 may have a hollow profile. Accordingly, the first through holes 52 and the second through holes 54 may pass through an upper surface 60 (see, e.g., FIG. 3) and the lower surface 62 of the stiffening beam 50, thereby forming an upper first through hole through the upper surface 60 and a lower first through hole through the lower surface 62. In the same manner, the second through holes 54 may pass through the upper surface 60 and the lower surface 62 of the stiffening beam 50, thereby forming an upper second through hole through the upper surface 60 and a lower second through hole through the lower surface 62.

The bushing 56, which is hollow in its center (e.g., which has a hollow center), passes through the upper second through hole and is fixed thereon. For example, the hollow center of the bushing 56 extends through the second through hole 54 from the lower surface 62 to a peripheral end of the bushing 56 facing away from the upper surface 60. The fixation of the bushing 56 may be provided in a form-fitting manner, in a force-fitting manner, and/or in a materially bonded manner. In the illustrated embodiment, the bushing 56 is fixed in a form-fitting manner by inserting the bushing 56 from the lower surface 62 side through the lower second through hole. Therefore, the lower second through hole may be larger than the upper second through hole.

In the illustrated embodiment, the bushings 56 are arranged in pairs of two. Further, the pairs of bushings 56 are alternately arranged and spaced apart from the center of the stiffening beam 50. This arrangement facilitates stiffening and resonance frequency adjustment. However, the bushings 56 may also be arranged in groups of three or more. In some embodiments, the bushings 56 may be arranged in one line. The line may be at the center of the stiffening beam 50 or may be at a distance from (e.g., offset from) the center of the stiffening beam 50.

Referring back to FIG. 1, the stiffening beam 50 may not be connected to all of the bottom plates 30, which also dampens propagation of certain frequencies, which thereby may be suppressed.

FIG. 3 is a schematic perspective view of the stiffening beam 50 according to the embodiment shown in FIG. 2 but flipped by 180° along the first end 64. The explanations regarding FIGS. 1 and 2 apply accordingly. Referring to FIG. 3, the bushings 56 extend perpendicularly from the upper surface 60 of the stiffening beam 50. The height of the bushings 56 may depend on the height of the structural element 32 of the bottom plate 30. For example, the bushing 56 may be formed such that a firm connection between the stiffening beam 50 and the bottom plate 30 can be established. The stiffening beam 50 may have third through holes (e.g., third openings) 68 for fixation to the side beams 12A, 12B.

According to an embodiment, the width of the stiffening beam 50 may be more than 1/30 of the width of the carrier framework 100 (where width refers to the extension in Y-direction in FIG. 1). By adjusting (or varying) the width of the stiffening beam 50 in relation to the overall width of the carrier framework 100, the stiffness of the carrier framework 100 can be flexibly adjusted, for example, adjusted to different classes of battery packs. To further increase stiffness, the stiffening beam 50 may be more than 1/20 of the width of the carrier framework 100. In other embodiments, the stiffening beam 50 may be more than 1/10 of the width of the carrier framework 100. In one embodiment, the width of the stiffening beam 50 may be selected such that a resonance frequency of the battery pack is equal to or more than about 45 Hz.

FIG. 4 is a schematic cross-sectional view of the stiffening beam 50 taken along the line A-A′ in FIG. 3. The explanations regarding FIGS. 1 to 3 apply accordingly. The cross-sectional view of FIG. 4 shows that hollow interior of the stiffening beam 50. In some embodiments, the stiffening beam 50 may include a wall 72. In such an embodiment, the wall 72 separates the hollow stiffening beam 50 into two hollow chambers 58, each extending in the longitudinal direction of the stiffening beam 50. The hollow chambers 58 allow for saving weight compared to a solid beam, while maintaining a high degree of rigidity. Further, by providing two hollow chambers 58, even if one chamber has through holes, the other chamber may still maintain stiffness in the same or corresponding area. Therefore, the wall 72 provides the stiffening beam 50 with a higher degree of stiffness with only minimal additional material use. The material used for the stiffening beam 50 may be a metal, such as aluminum.

FIG. 5 is a schematic cross-sectional view of the stiffening beam 50 taken along the line B-B′ in FIG. 3. The explanations regarding FIGS. 1 to 4 apply accordingly. However, FIG. 5 illustrates another embodiment in which the structural element 32 has a different shape than the previously-described embodiment. That is, while the structural element 32 of the bottom plate 30 shown in FIG. 1 has a U-shaped contour, the structural element 32 of the bottom plate 30 shown in FIG. 5 has an X-shaped cross-section when including the bottom plate 30. For example, the lower legs of the X-shape are compressed such that a resting surface of the legs on the upper surface 60 of the stiffening beam 50 is enlarged. The middle of the X-shape is hollow. The hollow portion may be, in a cross-section view, star shaped. The structural element 32 extends along the longitudinal direction of the bottom plate 30. For example, the longitudinal direction of the bottom plate 30 is perpendicular to the longitudinal direction of the stiffening beam 50. The structural elements 32 may be formed such that, when two bottom plates 30 are arranged next to each other, a bushing 56 fits between both structural elements 32. When the stiffening beam 50 is fixed to the bottom plate 30, a fixing element 70, such as a screw or bolt, is inserted through the second through hole 54, that is, the lower second through hole and the upper second through hole, into a fixing structure 74.

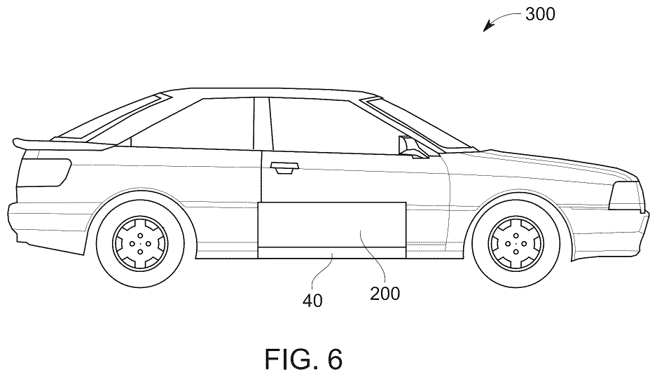

Besides the carrier framework 100 described above and the batteries accompanied therein, a battery pack 200 generally includes monitoring and control technology, temperature control units, and the like. FIG. 6 illustrates a schematic view of an electric vehicle 300 including the battery pack 200. The electric vehicle 300 may include an underrun protection cover 40. The stiffening beam 50 may be arranged between the underrun protection cover 40 and the bottom plates 30, which ensures that the space between the bottom plates 30 and the underrun protection cover 40 is used efficiently by the stiffening beam 50. That is, no additional space is required for the stiffening beam 50. In other words, the shape of the stiffening beam 50 may be selected such that no additional space is required below the carrier framework 100.

### DESCRIPTION OF SOME REFERENCE SYMBOLS

10 frame
12A first side beam along a first direction
12B second side beam along a first direction
14A first side beam along a second direction
14B second side beam along a second direction
16A first angled beam
16B second angled beam
20A first cross beam
20B second cross beam
30 bottom plate
32 structural element
40 underrun protection cover
50 stiffening beam
52 first through hole
54 second through hole
56 bushing
58 hollow chamber
60 upper surface
62 lower surface
64 first end
66 second end
68 third through hole
70 fixing element
72 wall
74 fixing structure
100 carrier framework
200 battery pack
300 electric vehicle

What is claimed is:

1. A carrier framework for a battery pack, the carrier framework comprising:
a frame comprising two pairs of opposing side beams;
a cross beam connecting a first pair of the opposing side beams of the frame; and
a stiffening beam fixed to a second pair of the opposing side beams of the frame and to the cross beam.

2. The carrier framework as claimed in claim 1, wherein the stiffening beam has first through holes for fixing the stiffening beam to the cross beam.

3. The carrier framework as claimed in claim 2, further comprising bottom plates extending between the cross beam and the side beams, the bottom plates being fixed to the stiffening beam.

4. The carrier framework as claimed in claim 3, wherein the bottom plates have structural elements on a side facing the stiffening beam that protrude from a plane of the bottom plates and rest against the stiffening beam.

5. The carrier framework as claimed in claim 4, wherein the stiffening beam has second through holes in an area not facing the structural elements of the bottom plates and comprises bushings attached to the second through holes and extending to the bottom plate, and
wherein the stiffing beam is fixed to the bottom plates via the bushing.

6. The carrier framework as claimed in claim 4, wherein the structural elements have a U-shaped contour on the side facing the stiffening beam, the U-shaped contour extending transversely to the stiffening beam.

7. The carrier framework as claimed in claim 1, wherein the stiffening beam has a hollow profile.

8. The carrier framework as claimed in claim 7, wherein the hollow profile has a plurality of hollow chambers.

9. The carrier framework as claimed in claim 8, wherein the stiffening beam comprises a wall between adjacent ones of the hollow chambers.

10. The carrier framework as claimed in claim 1, wherein the stiffening beam comprises aluminum.

11. A battery pack comprising the carrier framework as claimed in claim 1.

12. An electric vehicle comprising the battery pack as claimed in claim 11.

13. The electric vehicle as claimed in claim 12, further comprising an underrun protection cover,
wherein the battery pack further comprises bottom plates extending between the cross beam and the side beams, the bottom plates being fixed to the stiffening beam, and
wherein the stiffening beam is between the underrun protection cover and the bottom plates.
